(19) United States
(12) Patent Application Publication
(10) Pub. No.: US 2026/0081081 A1
(43) Pub. Date: Mar. 19, 2026

(54) CAPACITOR, ELECTRIC CIRCUIT, CIRCUIT BOARD, AND APPARATUS

(71) Applicant: Panasonic Intellectual Property Management Co., Ltd., Osaka (JP)

(72) Inventors: Naoya KITAMURA, Osaka (JP); Ryosuke KIKUCHI, Osaka (JP); Manabu KANOU, Osaka (JP); Hiroshi ASANO, Osaka (JP); Hisanori MASHIKO, Osaka (JP); Takehito GOTO, SAGA (JP)

(21) Appl. No.: 19/401,919

(22) Filed: Nov. 26, 2025

Related U.S. Application Data
(63) Continuation of application No. PCT/JP2024/019959, filed on May 30, 2024.

(30) Foreign Application Priority Data
Jun. 1, 2023 (JP) 2023-090835

(51) Int. Cl. H01G 9/025; H01G 9/04; H01G 9/052; H01G 9/15; H01G 9/28

(52) U.S. Cl. CPC H01G 9/025; H01G 9/0525; H01G 9/15; H01G 9/28; H01G 2009/05

(57) ABSTRACT

A capacitor includes metallic tantalum, a solid electrolyte, and a tantalum oxide film. The tantalum oxide film is disposed between the metallic tantalum and the solid electrolyte. A first portion includes fluorine. A second portion is in contact with the first portion, the second portion being closer to the solid electrolyte than the first portion in a thickness direction of the tantalum oxide film. A fluorine concentration in the second portion is lower than a fluorine concentration in the first portion.

This application is a continuation of PCT/JP2024/019959 filed on May 30, 2024, which claims foreign priority of Japanese Patent Application No. 2023-090835 filed on Jun. 1, 2023, the entire contents of both of which are incorporated herein by reference.

### BACKGROUND OF THE INVENTION

### 1. Field of the Invention

The present invention relates to a capacitor, an electrical circuit, a circuit board, and an apparatus.

### 2. Description of Related Art

It has been known that a fluorine-including tantalum oxide is included in capacitors.

For example, JP 2005-294402 A describes a solid electrolytic capacitor including a dielectric layer formed of tantalum oxide including fluorine. The dielectric layer is formed by anodic oxidation of an anode formed of tantalum in an aqueous solution containing fluorine ions. An electrolyte layer formed of manganese dioxide is provided on the dielectric layer.

In Journal of Materials Chemistry C, (UK), 2020, Issue 14, pp. 4680-4684, a thin polycrystalline TaO₂F film having a relative permittivity of 60 at 1 MHz is described.

### SUMMARY OF THE INVENTION

The present disclosure provides a capacitor including a fluorine-including tantalum oxide, the capacitor being advantageous in terms of suppressing capacitance degradation due to a solid electrolyte.

A capacitor of the present disclosure includes:
metallic tantalum;
a solid electrolyte; and
a tantalum oxide film disposed between the metallic tantalum and the solid electrolyte, wherein
the tantalum oxide film includes a first portion including fluorine and a second portion in contact with the first portion, the second portion being closer to the solid electrolyte than the first portion in a thickness direction of the tantalum oxide film, and
a fluorine concentration in the second portion is lower than a fluorine concentration in the first portion.

The present disclosure can provide a capacitor including a fluorine-including tantalum oxide, the capacitor being advantageous in terms of suppressing capacitance degradation due to a solid electrolyte.

### BRIEF DESCRIPTION OF THE DRAWINGS

FIG. 1 is a cross-sectional view showing an example of the capacitor of the present disclosure.

FIG. 2 is a cross-sectional view showing another example of the capacitor of the present disclosure.

FIG. 3A is a cross-sectional view showing yet another example of the capacitor of the present disclosure.

FIG. 3B is a cross-sectional view showing yet another example of the capacitor of the present disclosure.

FIG. 4A schematically shows an example of the electrical circuit of the present disclosure.

FIG. 4B schematically shows an example of the circuit board of the present disclosure.

FIG. 4C schematically shows an example of the apparatus of the present disclosure.

FIG. 5 is a graph showing a relation between an atomic ratio between fluorine (F), tantalum (Ta), and oxygen (O) and the depth in a depth profile obtained from a sample according to Example 1A by Rutherford backscattering spectrometry (RBS).

FIG. 6 is a graph showing a relation between signal intensities of F⁻, TaO³⁻, and O⁻ and the depth in a depth profile obtained from a sample according to Example 1B by time-of-flight secondary ion mass spectrometry (TOF-SIMS).

FIG. 7 is a graph showing a relation between signal intensities of F⁻, TaO³⁻, and O⁻ and the depth in a depth profile obtained from the sample according to Comparative Example 1 by TOF-SIMS.

FIG. 8 is a graph showing capacitance ratios of Examples 2A to 2E and Comparative Example 2.

FIG. 9 is a graph showing an XRD pattern of a dielectric film of a sample according to Reference Example 1.

FIG. 10 is a graph showing a relation between signal intensities of F⁻, TaO³⁻, and O⁻ and the depth in a depth profile obtained from the sample according to Reference Example 1 by TOF-SIMS.

FIG. 11 is a graph showing a relation between signal intensities of F⁻, TaO³⁻, and O⁻ and the depth in a depth profile obtained from a sample according to Comparative Example 3 by TOF-SIMS.

FIG. 12A is a graph showing a relation between the capacitance of a capacitor and the frequency.

FIG. 12B is a graph showing a relation between the capacitance of a capacitor and the frequency.

FIG. 13A is a graph showing a relation between the dielectric loss tangent tan δ of a capacitor and the frequency.

FIG. 13B is a graph showing a relation between the dielectric loss tangent tan δ of a capacitor and the frequency.

### DETAILED DESCRIPTION

### Findings on which the Present Disclosure is Based

For example, there is a continuous demand for improving processing performance of electronic apparatuses. Performance of an electronic component, such as a capacitor, greatly affects performance of an electronic apparatus in which the component is embedded. Therefore, it is expected that there will be an increasing need for small high-performance capacitors. Electrolytic capacitors, for example, are known as capacitors. In an electrolytic capacitor, a dielectric formed of a thin oxidized film is provided on a surface of metallic aluminum or metallic tantalum by chemical conversion of aluminum or tantalum. For electrolytic capacitors, attempts have been made to increase the capacitance of a capacitor mainly by increasing the specific surface area of a dielectric. However, such attempts have limitations. It is thought that the capacitor performance will be able to be improved further by developing dielectrics having higher permittivities.

For example, the thin polycrystalline TaO₂F film described in Journal of Materials Chemistry C, (UK), 2020, Issue 14, pp. 4680-4684 has a high relative permittivity. It is believed that a polycrystal of an oxyfluoride of tantalum has a crystal state different from that of tantalum oxide Ta₂O₅ and hence has a larger polarization and a higher relative permittivity. Moreover, the present inventors found that a fluorine-including tantalum oxide has a higher relative permittivity than fluorine-free tantalum oxide Ta₂O₅ even when the fluorine-including tantalum oxide is amorphous. As just described, a capacitor including a fluorine-including tantalum oxide is expected to have a higher capacitance. Meanwhile, the studies by the present inventors revealed that disposing a solid electrolyte in contact with a fluorine-including tantalum oxide film can decrease the capacitance of a capacitor.

The reason why disposing a solid electrolyte in contact with a fluorine-including tantalum oxide film decreases the capacitance of a capacitor remains unclear. The present inventors assumed that a high affinity between the fluorine-including tantalum oxide film and the solid electrolyte may affect the contact area between the fluorine-including tantalum oxide film and the solid electrolyte, thereby decreasing the capacitance of the capacitor.

In view of these circumstances, the present inventors made an intensive study on configuration of a capacitor including a fluorine-including tantalum oxide, the capacitor being configured to suppress capacitance degradation due to a solid electrolyte. As a result, the present inventors newly discovered that a film of a tantalum oxide having particular configuration is advantageous in terms of suppressing capacitance degradation due to a solid electrolyte. On the basis of this new finding, the present inventors have completed the capacitor of the present disclosure.

### Embodiments

Embodiments of the present disclosure will be described hereinafter with reference to the drawings. The present disclosure is not limited to the following embodiments.

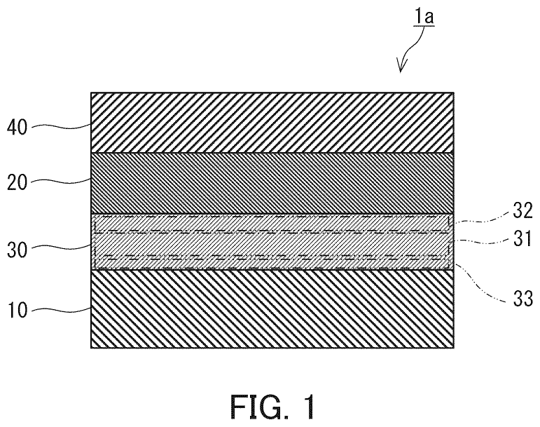

FIG. 1 is a cross-sectional view showing an example of the capacitor of the present disclosure. As shown in FIG. 1, a capacitor 1a includes metallic tantalum 10, a solid electrolyte 20, and a tantalum oxide film 30. The tantalum oxide film 30 is disposed between the metallic tantalum 10 and the solid electrolyte 20. The tantalum oxide film 30 includes a first portion 31 and a second portion 32. The tantalum oxide film 30 further includes, for example, a third portion 33. The first portion 31 includes fluorine. The second portion 32 is in contact with the first portion 31 and is closer to the solid electrolyte 20 than the first portion 31 in a thickness direction of the tantalum oxide film 30. The third portion 33 is in contact with the first portion 31 and is closer to the metallic tantalum 10 than the first portion 31 in the thickness direction of the tantalum oxide film 30. In other words, the first portion 31 is, for example, disposed between the second portion 32 and the third portion 33 in the thickness direction of the tantalum oxide film 30. In the tantalum oxide film 30, a fluorine concentration in the second portion 32 and a fluorine concentration in the third portion 33 are lower than a fluorine concentration in the first portion 31.

Since the tantalum oxide film 30 includes the first portion 31 including fluorine, the tantalum oxide film 30 is likely to have a high relative permittivity. Hence, the capacitor 1a is likely to have a high capacitance. Since the tantalum oxide film 30 includes the second portion 32, capacitance degradation due to the solid electrolyte 20 is likely to be suppressed. Although unclear, the reason for this may be that the affinity between the tantalum oxide film 30 and the solid electrolyte 20 is likely to be high and thus the contact area between the tantalum oxide film 30 and the solid electrolyte 20 is likely to be large.

A capacitance ratio of the capacitor 1a is, for example, 83% or more. The capacitance ratio is a ratio C₁/C₀ of an electrostatic capacitance C₁ of the capacitor 1a to an electrostatic capacitance C₀ measured before the capacitor 1a is provided with the solid electrolyte 20. The electrostatic capacities C₀ and C₁ can be determined, for example, by the method described in EXAMPLES.

According to JP 2005-294402 A, a dielectric layer is formed by anodic oxidation of an anode formed of tantalum in an aqueous solution containing fluorine ions. According to JP 2005-294402 A, an equivalent series resistance (ESR) of an electrolytic capacitor is small because the dielectric layer is formed of tantalum oxide including fluorine. According to the studies by the present inventors, a film obtained by anodic oxidation of tantalum in an aqueous solution containing fluorine ions can have a high dielectric loss tangent. In such a film, the ion diffusion rate of fluoride ions is twice or more the ionic diffusion rate of oxide ions. Depending on anodic oxidation conditions, fluorine can gather at the interface between the tantalum oxide and elemental tantalum to form a region where the fluorine concentration is high. It is thought that the formation of the region where the fluorine concentration is high at the interface between the tantalum oxide and the elemental tantalum results in the increase of the dielectric loss tangent of the film. In contrast, since the tantalum oxide film 30 includes, for example, the third portion 33, the fluorine concentration at the interface between the tantalum oxide film 30 and the metallic tantalum 10 is less likely to be high. Hence, the capacitor 1a is likely to have a low dielectric loss tangent.

The dielectric loss tangent of the capacitor 1a is, for example, 0.20 or less in the frequency range from 1 Hz to 10 KHz.

As shown in FIG. 1, the first portion 31, the second portion 32, and the third portion 33 are each, for example, a portion in a layer form.

A boundary between the first portion 31 and the second portion 32 and a boundary between the first portion 31 and the third portion 33 in the tantalum oxide film 30 can be defined, for example, according to a depth profile obtained by TOF-SIMS. For example, in a depth profile obtained by TOF-SIMS, the maximum of the signal intensity of a fluoride ion (F⁻) in the first portion 31 is measured. Moreover, in the depth profile, a pair of depths corresponding to half of the maximum is determined. Of the pair of depths, the position corresponding to the depth closer to the metallic tantalum 10 is defined as the boundary between the first portion 31 and the third portion 33, while the position corresponding to the other depth is defined as the boundary between the first portion 31 and the second portion 32. The boundary between the first portion 31 and the second portion 32 and the boundary between the first portion 31 and the third portion 33 in the tantalum oxide film 30 may be determined by Rutherford backscattering spectrometry (RBS).

A boundary between the metallic tantalum 10 and the tantalum oxide film 30 in the capacitor 1a can be determined, for example, according to a depth profile obtained by TOF-SIMS. For example, the maximum signal of a tantalum oxide ion (TaO³⁻) in the depth range corresponding to the first portion 31 is determined in the depth profile. A depth corresponding to half of the maximum is determined, and a position corresponding to the depth is defined as the boundary between the metallic tantalum 10 and the tantalum oxide film 30. The boundary between the metallic tantalum 10 and the tantalum oxide film 30 may be defined by RBS.

The depth profiles obtained from the tantalum oxide film 30 by TOF-SIMS and RBS are not limited to particular forms as long as the fluorine concentration in the second portion 32 is lower than the fluorine concentration in the first portion 31. For example, a ratio A_{33F}/A_{31F} of an average A_{33F} to an average A_{31F} is 0.5 or less. The average A_{31F} is the average of the signal intensity of a fluoride ion (F⁻) in the first portion 31. The average A_{33F} is the average of the signal intensity of a fluoride ion (F⁻) in the second portion 32. In this case, capacitance degradation due to the solid electrolyte 20 is likely to be suppressed more efficiently. The ratio A_{33F}/A_{31F} may be 0.2 or less, 0.15 or less, or 0.129 or less. The ratio A_{33F}/A_{31F} is, for example, 0.01 or more, and may be 0.05 or more, or 0.1 or more.

In the depth profile obtained from the tantalum oxide film 30 by TOF-SIMS, a ratio A_{32F}/A_{31F} of an average A_{32F} to the average A_{31F} is, for example, 0.9 or less. The average A_{32F} is the average of the signal intensity of a fluoride ion (F⁻) in the third portion 33. In this case, the capacitor 1a is more likely to have a low dielectric loss tangent. The ratio A_{32F}/A_{31F} may be 0.5 or less, 0.4 or less, or 0.379 or less. The ratio A_{32F}/A_{31F} is, for example, 0.01 or more, and may be 0.05 or more, or 0.1 or more.

In a depth profile of elements or ions in the tantalum oxide film 30, a coefficient of variation of signal intensity of oxygen (O) or an oxygen ion (O⁻) in the first portion 31 and the second portion 32 is not limited to a particular value. The coefficient of variation is, for example, 0.09 or less. In this case, variation in the signal intensity of an oxygen ion (O⁻) is small in the first portion 31 and the second portion 32, and the capacitor 1a is more likely to have a high capacitance. The coefficient of variation may be 0.088 or less, 0.05 or less, or 0.01 or less. The coefficient of variation can be determined by dividing the standard deviation by the average.

A thickness t₃₀ of the tantalum oxide film 30 is not limited to a particular value. The thickness t₃₀ is, for example, 1 nm or more and 1 μm or less.

The first portion 31 may be crystalline or amorphous. Even when the first portion 31 is amorphous, the tantalum oxide film 30 is likely to have a high relative permittivity, and the capacitor 1a is likely to have a high capacitance. For example, when a broad halo pattern appears in an XRD pattern obtained from an object using Cu-Kα radiation at diffraction angles 2θ from 10° to 50°, the object can be concluded to be amorphous.

The second portion 32 may be crystalline or amorphous. The third portion 33 may be crystalline or amorphous.

The composition of the first portion 31 is not limited to a particular composition as long as the fluorine concentration in the second portion 32 is lower than the fluorine concentration in the first portion 31. The first portion 31 is, for example, free of silicon and titanium. The first portion 31 has, for example, a composition represented by TaOₓ₁F_{y1}. This composition satisfies, for example, requirements 0<x1<2.5 and 0<y1≤0.4. In this case, the tantalum oxide film 30 is likely to have a high relative permittivity, and the capacitor 1a is likely to have a high capacitance. Moreover, in this case, the fluorine included in the tantalum oxide film 30 is likely to be prevented from being affected by an electric field, heat, or the like and thereby diffusing toward the metallic tantalum 10, and the dielectric loss tangent is likely to be lowered.

In the above composition, for example, a requirement y1≥0.015 is satisfied. In this case, the tantalum oxide film 30 is more likely to have a high relative permittivity, and the capacitor 1a is more likely to have a high capacitance. In the above composition, a requirement y1≥0.016, y1≥0.017, y1≥0.018, y1≥0.019, y1≥0.02, or y1≥0.03 may be satisfied. In the above composition, y1≤0.3 or y1≤0.2 may be satisfied.

The fluorine concentration in the second portion 32 is not limited to a particular value as long as the fluorine concentration in the second portion 32 is lower than the fluorine concentration in the first portion 31. The second portion 32 has a composition represented by TaOₓ₂F_{y2}. This composition satisfies, for example, requirements 0<x2<2.5 and 0≤y2<0.015. In this case, capacitance degradation due to the solid electrolyte is more likely to be suppressed.

The fluorine concentration in the third portion 33 is not limited to a particular value as long as the fluorine concentration in the third portion 33 is lower than the fluorine concentration in the first portion 31. The third portion 33 has, for example, a composition represented by TaOₓ₃F_{y3}. This composition satisfies, for example, requirements 0<x3<2.5 and 0≤y3<0.015. In this case, the fluorine concentration in the tantalum oxide film 30 is even less likely to be increased in the vicinity of the metallic tantalum 10, and the dielectric loss tangent of the capacitor 1a is more likely to be lowered.

The values of x1, y1, x2, y2, x3, and y3 in the above composition can be determined, for example, according to the result of RBS. The values of x1, y1, x2, y2, x3, and y3 may be determined by a combination of TOF-SIMS and another method, such as RBS.

The solid electrolyte 20 is not limited to a particular solid electrolyte. The solid electrolyte 20 may include, for example, an electrically conductive polymer or a manganese compound, such as manganese oxide. Examples of the electrically conductive polymer include polypyrrole, a polythiophene, polyaniline, and derivatives of these. The solid electrolyte 20 forms, for example, a layer.

As shown in FIG. 1, the capacitor 1a further includes, for example, an electrical conductor 40. The solid electrolyte 20 is disposed between the tantalum oxide film 30 and the electrical conductor 40 in a thickness direction of the tantalum oxide film 30. The material of the electrical conductor 40 is not limited to a particular material. The electrical conductor 40 may include a valve metal, such as aluminum, tantalum, niobium, or bismuth, may include a noble metal, such as gold or platinum, or may include nickel. The electrical conductor 40 may include a carbon material, such as graphite.

In the capacitor 1a, for example, a cathode is formed of the electrical conductor 40 and the solid electrolyte 20.

The method for forming the tantalum oxide film 30 is not limited to a particular method. The tantalum oxide film 30 is formed, for example, by a method including (I), (II), and (III) below.
(I) The metallic tantalum is subjected to anodization with the metallic tantalum in contact with an aqueous fluorine-free solution, thereby forming an oxide layer in contact with the metal tantalum.
(II) The metallic tantalum is subjected to anodization with the oxide layer formed in the above step (I) in contact with an aqueous fluorine-containing solution, thereby giving an oxide layer.
(III) The metallic tantalum is subjected to anodization with the oxide layer formed in the above step (II) in contact with an aqueous fluorine-free solution, thereby giving the tantalum oxide film 30 including the first portion 31, the second portion 32, and the third portion 33.

During the anodization, for example, a voltage within the range of several volts [V] to several hundred volts [V] is applied between an anode and a cathode with an electrolyte disposed therebetween. For example, a voltage of 5 volts [V] to 300 volts [V] is applied. When the metallic tantalum is an anode, an anion attracted to the metallic tantalum and ionized tantalum are bonded to form a conversion coating. In this process, ions or atoms being electrolyte-derived impurities around the anode can be incorporated into the conversion coating. Therefore, it is practically impossible to form a film consisting only of two specific elements such as tantalum and oxygen in the anodization in which the metallic tantalum is used as an anode. Hence, for example, the second portion 32 and the third portion 33 can include 0.4% or less of an element, such as fluorine, other than tantalum and oxygen on the basis of the number of atoms.

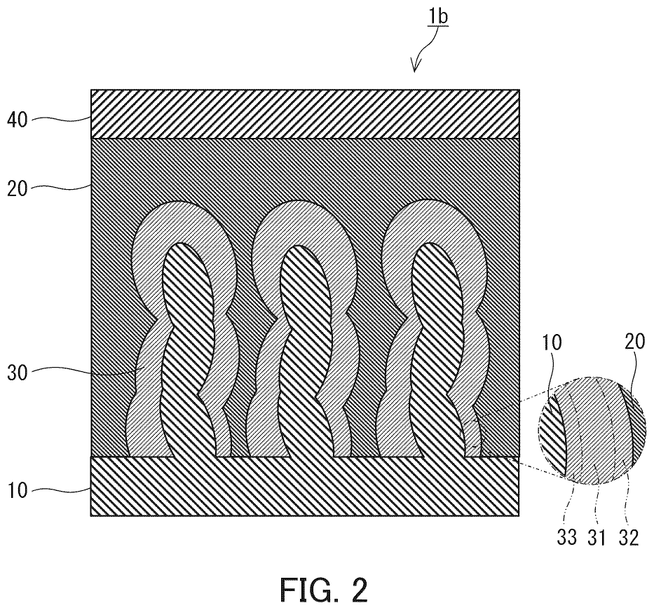

FIG. 2 is a cross-sectional view showing another example of the capacitor of the present disclosure. A capacitor 1b shown in FIG. 2 is configured in the same manner as the capacitor 1a unless otherwise described. The components of the capacitor 1b that are the same as or correspond to the components of the capacitor 1a are denoted by the same reference characters, and detailed descriptions of such components are omitted. The description given for the capacitor 1a is applicable to the capacitor 1b unless there is a technical inconsistency.

As shown in FIG. 2, at least a portion of the metallic tantalum 10 of the capacitor 1b is porous. This makes it likely that the metallic tantalum 10 has a large surface area and the capacitor 1b has a high capacitance. The porous structure can be formed, for example, by etching of a metallic foil, sintering of powder, or the like.

As shown in FIG. 2, the tantalum oxide film 30 is disposed on the porous portion of the metallic tantalum 10. The tantalum oxide film 30 is formed, for example, by anodization. The solid electrolyte 20 is disposed so as to fill a space around the porous portion of the tantalum oxide film 30. In the capacitor 1b, for example, a cathode is formed of the electrical conductor 40 and the solid electrolyte 20. The electrical conductor 40 may include, for example, a solidified body of a silver-including paste, a carbon material such as graphite, or both the solidified body and the carbon material.

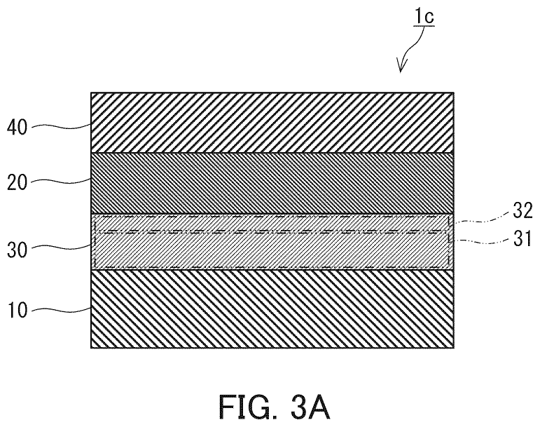

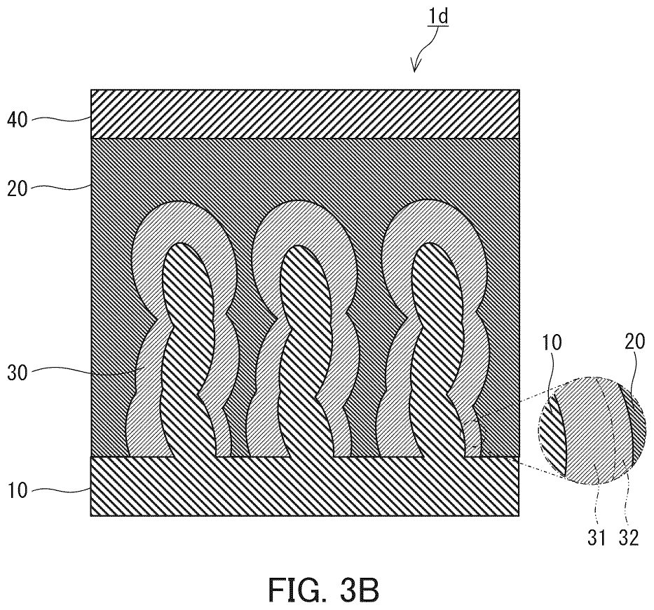

FIGS. 3A and 3B are cross-sectional views each showing yet another example of the capacitor of the present disclosure. A capacitor 1c shown in FIG. 3A and a capacitor 1d shown in FIG. 3B are configured in the same manner as the capacitors 1a and 1b unless otherwise described. The components of the capacitors 1c and 1d that are the same as or correspond to the components of the capacitors 1a and 1b are denoted by the same reference characters, and detailed descriptions of such components are omitted. The description given for the capacitors 1a and 1b is applicable to the capacitors 1c and 1d unless there is a technical inconsistency.

As shown in FIGS. 3A and 3B, in the capacitor 1c and the capacitor 1d, the tantalum oxide film 30 includes the first portion 31 and the second portion 32, but is free of the third portion 33. In the capacitor 1c and the capacitor 1d, for example, the first portion 31 is in contact with the metallic tantalum 10. Even in the case of this configuration, capacitance degradation due to the solid electrolyte 20 is likely to be suppressed owing to the second portion 32 included in the tantalum oxide film 30. This tantalum oxide film 30 can be produced, for example, by adjusting anodization conditions in the above step (III) of a method including the above steps (I), (II), and (III). For example, this tantalum oxide film 30 is likely to be obtained by increasing the voltage applied between an anode and a cathode in the anodization in the above step (III).

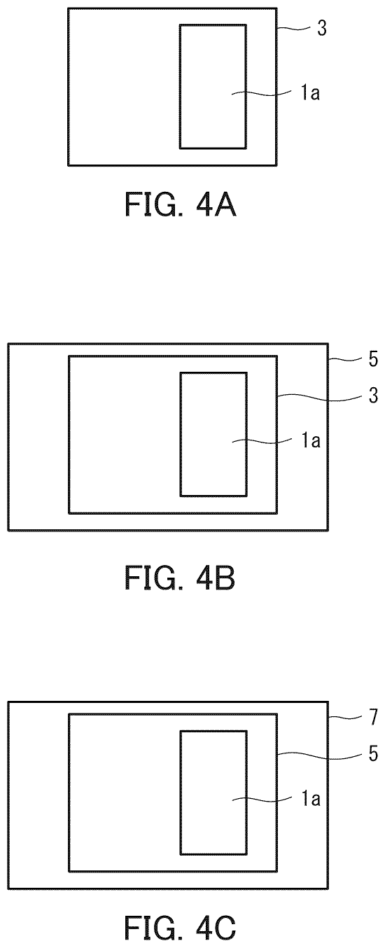

FIG. 4A schematically shows an example of the electrical circuit of the present disclosure. An electrical circuit 3 includes the capacitor 1a. The electrical circuit 3 may be an active circuit or a passive circuit. The electrical circuit 3 may be a discharging circuit, a smoothing circuit, a decoupling circuit, or a coupling circuit. Since including the capacitor 1a, the electrical circuit 3 is likely to exhibit desired performance. For example, noise is likely to be reduced in the electrical circuit 3. The electric circuit 3 may include the capacitor 1b.

FIG. 4B schematically shows an example of the circuit board of the present disclosure. As shown in FIG. 4B, a circuit board 5 includes the capacitor 1a. For example, the circuit board 5 includes the electrical circuit 3 including the capacitor 1a. Since the circuit board 5 includes the capacitor 1a, the circuit board 5 is likely to exhibit desired performance. The circuit board 5 may be an embedded board or a motherboard. The circuit board 5 may include the capacitor 1b.

FIG. 4C schematically shows an example of the apparatus of the present disclosure. As shown in FIG. 4C, an apparatus 7 includes the capacitor 1a. The apparatus 7 includes, for example, the circuit board 5 including the capacitor 1a. Since including the capacitor 1a, the apparatus 7 is likely to exhibit desired performance. The apparatus 7 may be an electronic device, a communication device, a signal-processing device, or a power-supply device. The apparatus 7 may be a server, an AC adapter, an accelerator, or a flat-panel display such as a liquid crystal display (LCD). The apparatus 7 may be a USB charger, a solid-state drive (SSD), an information terminal such as a PC, a smartphone, or a tablet PC, or an Ethernet switch. The apparatus 7 may include the capacitor 1b.

### Supplement

According to the description of the above embodiments, the following techniques are disclosed.

### Technique 1

A capacitor including:
metallic tantalum;
a solid electrolyte; and
a tantalum oxide film disposed between the metallic tantalum and the solid electrolyte, wherein
the tantalum oxide film includes a first portion including fluorine and a second portion in contact with the first portion, the second portion being closer to the solid electrolyte than the first portion in a thickness direction of the tantalum oxide film, and
a fluorine concentration in the second portion is lower than a fluorine concentration in the first portion.

### Technique 2

The capacitor according to Technique 1, wherein
the tantalum oxide film further includes a third portion in contact with the first portion, the third portion being closer to the metallic tantalum than the first portion in the thickness direction of the tantalum oxide film, and
a fluorine concentration in the third portion is lower than the fluorine concentration in the first portion.

### Technique 3

The capacitor according to Technique 1, wherein the first portion is amorphous.

### Technique 4

The capacitor according to any one of Techniques 1 to 3, wherein
the first portion has a composition represented by TaOₓ₁F_{y1}, and
the composition satisfies a requirement 0<x1<2.5 and a requirement 0<y1≤0.4.

### Technique 5

The capacitor according to any one of Techniques 1 to 4, wherein
the second portion has a composition represented by TaOₓ₂F_{y2}, and
the composition satisfies a requirement 0<x2<2.5 and a requirement 0≤y2<0.015.

### Technique 6

The capacitor according to Technique 2, wherein
the third portion has a composition represented by TaOₓ₃F_{y3}, and
the composition satisfies a requirement 0<x3<2.5 and a requirement 0≤3<0.015.

### Technique 7

The capacitor according to any one of Techniques 1 to 6, wherein
in a depth profile of elements or ions in the tantalum oxide film, a coefficient of variation of signal intensity of oxygen (O) or an oxygen ion O⁻ in the first portion and the second portion is 0.09 or less.

### Technique 8

An electrical circuit including the capacitor according to any one of Techniques 1 to 7, wherein the capacitor is mounted to the electrical circuit.

### Technique 9

A circuit board including the capacitor according to any one of Techniques 1 to 7, wherein the capacitor is mounted to an electrical circuit formed on the circuit board.

### Technique 10

An apparatus including the capacitor according to any one of Techniques 1 to 7, wherein:
the capacitor is mounted to an electrical circuit formed on a circuit board, and
the apparatus is equipped with the circuit board.

### EXAMPLES

Hereinafter, the present disclosure will be described in more detail with reference to examples. The examples given below are just examples, and the present disclosure is not limited to them.

### Example 1A

Ultrasonic cleaning was performed for 10 minutes with a flat plate of metallic tantalum immersed in acetone, thereby washing the surface of the metallic tantalum. After that, acetone on the surface of the metallic tantalum was evaporated, and the surface of the metallic tantalum was washed with pure water. The metallic tantalum was then dried in air to give an anode foil.

The above anode foil and a platinum foil as a counter electrode were disposed such that they were partially immersed in an aqueous phosphoric acid solution with a given distance therebetween. The portion of the anode foil above the surface of the aqueous solution was connected to a positive electrode of a power-supply device, while the portion of the platinum foil above the surface of the aqueous solution was connected to a negative electrode of the power-supply device. A voltage of 97 V was applied between the anode foil and the platinum foil for 30 minutes to form a Ta₂O₅-including oxide layer on the surface of the anode foil. The anode foil was taken out of the aqueous solution, washed with pure water, and then dried in air.

Next, the above anode foil with the oxide layer and a platinum foil as a counter electrode were disposed such that they were partially immersed in an aqueous NH₄HF₂ solution with a given distance therebetween. The portion of the anode foil above the surface of the aqueous solution was connected to a positive electrode of a power-supply device, while the portion of the platinum foil above the surface of the aqueous solution was connected to a negative electrode of the power-supply device. A voltage of 156 V was applied between the anode foil and the platinum foil for 10 minutes to form a fluorine-including tantalum oxide layer. The anode foil was taken out of the aqueous solution, washed with pure water, and then dried in air.

Next, the above anode foil with the fluorine-including oxide layer and a platinum foil as a counter electrode were disposed such that they were partially immersed in an aqueous phosphoric acid solution with a given distance therebetween. The portion of the anode foil above the surface of the aqueous solution was connected to a positive electrode of a power-supply device, while the portion of the platinum foil above the surface of the aqueous solution was connected to a negative electrode of the power-supply device. A voltage of 187 V was applied between the anode foil and the platinum foil for 30 minutes to form a Ta₂O₅-including oxide layer. The anode foil was taken out of the aqueous solution, washed with pure water, and then dried in air. A sample according to Example 1A in which a dielectric film was provided on the surface of metallic tantalum was obtained in this manner.

### Example 1B

Ultrasonic cleaning was performed for 10 minutes with a flat plate of metallic tantalum immersed in acetone, thereby washing the surface of the metallic tantalum. After that, acetone on the surface of the metallic tantalum was evaporated, and the surface of the metallic tantalum was washed with pure water. The metallic tantalum was then dried in air to give an anode foil.

The above anode foil and a platinum foil as a counter electrode were disposed such that they were partially immersed in an aqueous phosphoric acid solution with a given distance therebetween. The portion of the anode foil above the surface of the aqueous solution was connected to a positive electrode of a power-supply device, while the portion of the platinum foil above the surface of the aqueous solution was connected to a negative electrode of the power-supply device. A voltage of 30 V was applied between the anode foil and the platinum foil for 13 hours to form a Ta₂O₅-including oxide layer on the surface of the anode foil. Then, the anode foil was taken out of the aqueous solution, washed with pure water, and then dried in air.

Next, the above anode foil with the oxide layer and a platinum foil as a counter electrode were disposed such that they were partially immersed in an aqueous mixture solution of NaF and a sodium phosphate buffer with a given distance therebetween. The portion of the anode foil above the surface of the aqueous mixture solution was connected to a positive electrode of a power-supply device, while the portion of the platinum foil above the surface of the aqueous mixture solution was connected to a negative electrode of the power-supply device. A voltage of 75 V was applied between the anode foil and the platinum foil for four hours to form a fluorine-including tantalum oxide layer. The NaF concentration and the sodium phosphate buffer concentration in the aqueous mixture solution were respectively 0.1 mol/L and 0.05 mol/L. The anode foil was taken out of the aqueous mixture solution, washed with pure water, and then dried in air.

Next, the above anode foil with the fluorine-including oxide layer and a platinum foil as a counter electrode were disposed such that they were partially immersed in an aqueous phosphoric acid solution with a given distance therebetween. The portion of the anode foil above the surface of the aqueous solution was connected to a positive electrode of a power-supply device, while the portion of the platinum foil above the surface of the aqueous solution was connected to a negative electrode of the power-supply device. A voltage of 90 V was applied between the anode foil and the platinum foil for four hours to form a Ta₂O₅-including oxide layer. The anode foil was taken out of the aqueous phosphoric acid solution, washed with pure water, and then dried in air. A sample according to Example 1B in which a dielectric film was provided on the surface of metallic tantalum was obtained in this manner.

### Comparative Example 1

A sample according to Comparative Example 1 was obtained in the same manner as in Example 1B, except that formation of an additional oxide layer on the anode foil with the fluorine-including oxide layer using an aqueous phosphoric acid solution was omitted.

### RBS

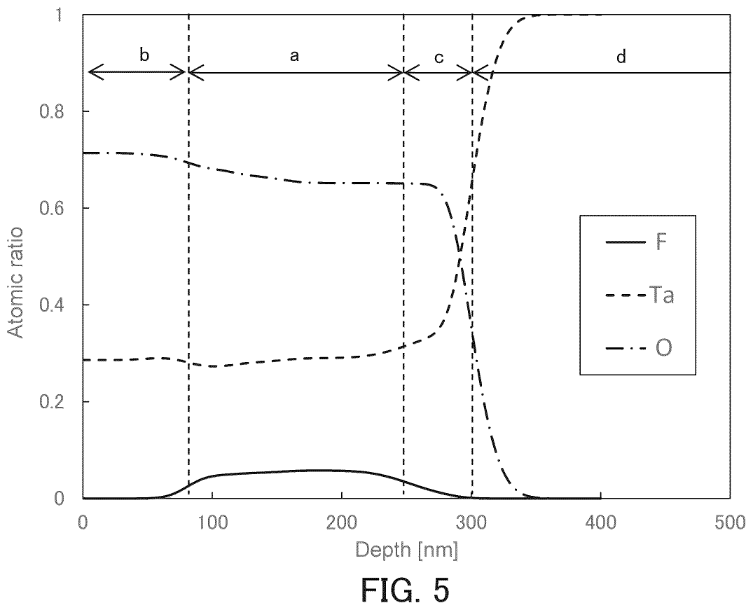

RBS was performed on specimens prepared from the dielectric layers of the samples according to Examples 1A and 1B using an RBS apparatus Pelletron 5SDH-2. In the RBS, the specimens were irradiated with ion beams under given conditions to give RBS spectra. FIG. 5 is a graph showing a relation between an atomic ratio of fluorine (F), tantalum (Ta), and oxygen (O) and the depth in a depth profile obtained from the sample according to Example 1A by the RBS. In FIG. 5, the vertical axis represents the atomic ratio between fluorine (F), tantalum (Ta), and oxygen (O), and the horizontal axis represents the depth. As shown in FIG. 5, the dielectric film of the sample according to Example 1A includes a portion a having a relatively high F concentration and portions b and c having relatively low F concentrations. Boundaries between the portion a and the portions b and c were defined by determining depths corresponding to half of the maximum of the F concentration in the portion a. The boundary between the portions b and a is understood to lie at a position corresponding to approximately 80 nm. The boundary between the portions c and a is understood to lie at a position corresponding to approximately 254 nm. Hence, it is understood that the portion a has a thickness of approximately 174 nm and that the portion b has a thickness of approximately 80 nm. A boundary between the dielectric film and the metallic tantalum was defined by determining a depth corresponding to half of the maximum of the signal intensity of TaO³⁻ in the portion a. The boundary between the dielectric film and the metallic tantalum was suggested to lie at a position corresponding to a depth of approximately 300 nm. Hence, it is understood that the portion c has a thickness of approximately 46 nm. No rise of the fluorine concentration was confirmed at the boundary between the dielectric film and the metallic tantalum. According to the RBS spectra obtained, compositions of the portions a of the dielectric layers of the samples according to Examples 1A and 1B are respectively TaO_{2.33}F_{0.19} and TaO_{2.27}F_{0.03}. In addition, compositions of the portions b of the dielectric layers of the samples according to Examples 1A and 1B are respectively TaO_{2.47} and TaO_{2.48}. An elemental concentration of fluorine in the portions b of the samples according to Examples 1A and 1B are lower than 0.4 mass %, which is the limit of detection, and y2<0.015 is established in the composition represented by TaOₓ₂F_{y2}. An elemental concentration of fluorine in the portions c of the samples according to Examples 1A and 1B are lower than 0.4 mass %, which is the limit of detection, and y3<0.015 is established in the composition represented by TaOₓ₃F_{y3}.

Comparison between Examples 2A to 2E and Comparative Example 2 described later suggests that, since including the portion b, the dielectric films of the samples according to Examples 1A and 1B more efficiently suppress capacitance degradation due to a solid electrolyte than the sample according to Comparative Example 1. Moreover, it is thought that, since the samples according to Examples 1A and 1B include the portion c, the dielectric loss tangent of a capacitor is easily lowered according to Reference Example 1 described later.

### TOF-SIMS

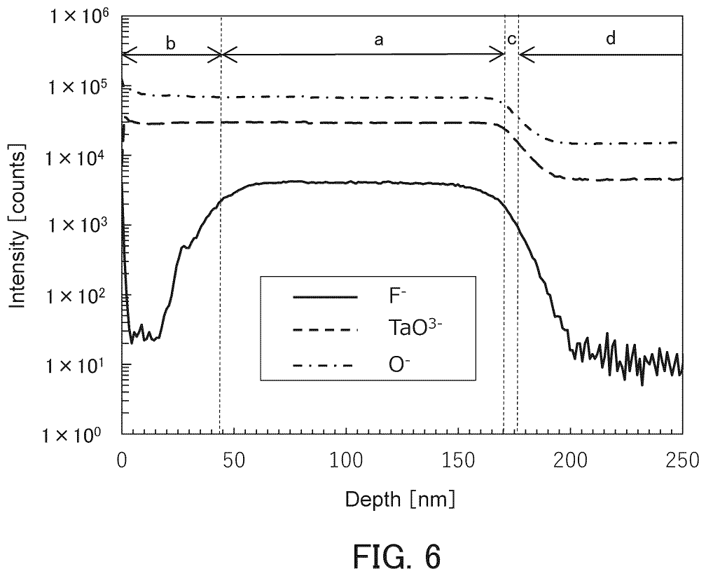

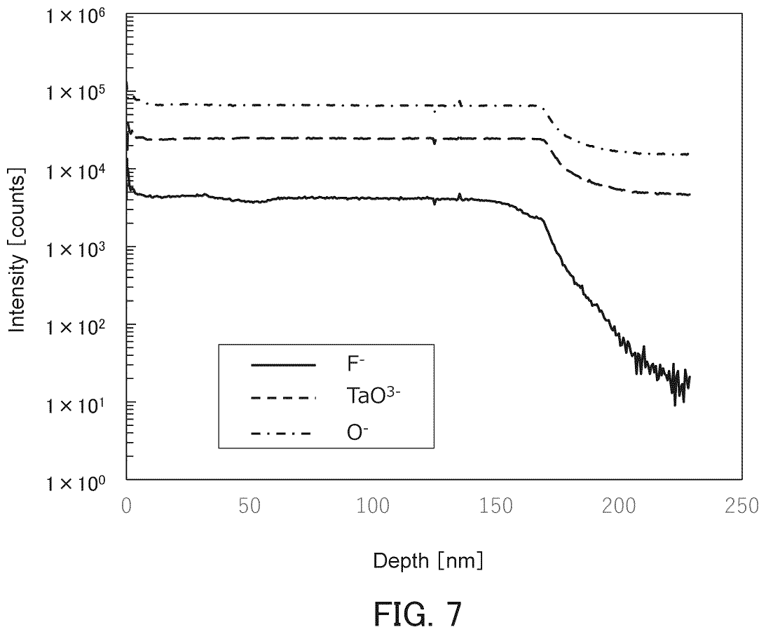

A piece having a given size was cut out of each of the samples according to Example 1B and Comparative Example 1, and a specimen for TOF-SIMS was prepared by resin embedding. TOF-SIMS was performed on the specimens prepared from the samples according to Example 1B and Comparative Example 1 using a TOF-SIMS apparatus TOF.SIMS 5 manufactured by IONTOF GmbH so as to perform composition analysis in the depth direction of the dielectric film. In the TOF-SIMS, a Bi beam was used as a primary ion beam. O₂⁺ was used as a sputtering ion species. FIG. 6 is a graph showing a relation between signal intensities of a fluoride ion (F⁻), a tantalum oxide ion (TaO³⁻), and an oxygen ion (O⁻) and the depth in a depth profile obtained from the sample according to Example 1B by TOF-SIMS. FIG. 7 is a graph showing a relation between signal intensities of F⁻, a tantalum oxide ion TaO³⁻, and O⁻ and the depth in a depth profile obtained from the sample according to Comparative Example 1 by TOF-SIMS. In FIGS. 6 and 7, the vertical axis represents the signal intensity of each ion, and the horizontal axis represents the depth of the dielectric film.

As shown in FIG. 6, the dielectric film of the sample according to Example 1B includes the portion a where the signal intensity of F⁻ is relatively high and the portions b and c where the signal intensity of F⁻ is relatively low. The boundaries between the portion a and the portions b and c were defined by determining depths corresponding to half of the maximum of the signal intensity of F⁻ in the portion a. The boundary between the portions b and a is understood to lie at a position corresponding to approximately 43 nm. The boundary between the portions c and a is understood to lie at a position corresponding to approximately 170 nm. Hence, it is understood that the portion a has a thickness of approximately 127 nm and that the portion b has a thickness of approximately 43 nm. The boundary between the dielectric film and the metallic tantalum was defined by determining a depth corresponding to half of the maximum of the signal intensity of TaO³⁻ in the portion a. The boundary between the dielectric film and the metallic tantalum was suggested to lie at a position corresponding to a depth of approximately 176 nm. Hence, it is understood that the portion c has a thickness of approximately 6 nm. No rise in the fluorine concentration was confirmed at the boundary between the dielectric film and the metallic tantalum.

In the portions b and a, no large variation of the signal intensity of O⁻ was confirmed, and the coefficient of variation of the signal intensity was approximately 0.088.

On the other hand, as shown in FIG. 7, it is understood that the dielectric film of the sample according to Comparative Example 1 is present from its surface to a depth of approximately 180 nm. In the sample according to Comparative Example 1, the fluorine concentration is almost constant from the surface of the dielectric film to a depth of approximately 170 nm.

### Example 2A

In a state where one end in a longitudinal direction of an anode lead formed of a metallic tantalum stick was embedded in metallic tantalum powder, the tantalum powder was formed into a rectangular parallelepiped to give a formed body. This formed body was sintered to give an anode body that had a porous structure and where the one end of the anode lead was embedded.

Next, the anode body was immersed in an aqueous phosphoric acid solution, and a voltage of 40 V was applied to the anode body for 13 hours using the anode lead to form a Ta₂O₅-including oxide layer on the surface of the anode body. The anode body was taken out of the aqueous phosphoric acid solution, washed with pure water, and then dried for 10 minutes in a drying oven regulated at 100° C.

Next, the anode body with the oxide layer was immersed in an aqueous NH₄HF₂ solution, and a voltage of 80 V was applied to the anode body for 10 minutes using the anode lead. A fluorine-including tantalum oxide layer was formed on the surface of the anode body in this manner.

Next, the anode body with the fluorine-including oxide layer was immersed in an aqueous phosphoric acid solution, and a voltage of 80 V was applied to the anode body for 30 minutes using the anode lead to form a Ta₂O₅-including oxide layer. The anode body was taken out of the aqueous phosphoric acid solution, washed with pure water, and then dried for 10 minutes in a drying oven regulated at 100° C. One hundred dielectric-film-coated anode bodies according to Example 2A each including a dielectric film formed on the surface of an anode body was obtained in this manner.

Next, a solid electrolyte layer including polythiophene was formed on the surface of each dielectric film of 50 of the dielectric-film-coated anode bodies according to Example 2A by chemical polymerization.

Next, a suspension of graphite particles was applied to the solid electrolyte layer and dried in air to form a carbon-including layer, and then a solution containing silver particles was applied to the carbon-including layer and dried in air to form a silver-including layer. Capacitors according to Example 2A were produced in this manner.

### Example 2B

An anode body prepared, in the same manner as in Example 2A, by sintering a formed body formed from tantalum powder was immersed in an aqueous phosphoric acid solution, and a voltage of 30 V was applied to the anode body for 13 hours using the anode lead to form a Ta₂O₅-including oxide layer on the surface of the anode body. The anode body was taken out of the aqueous phosphoric acid solution, washed with pure water, and then dried for 10 minutes in a drying oven regulated at 100° C.

Next, the anode body with the oxide layer was partially immersed in a solution mixture of NaF and a sodium phosphate buffer, and a voltage of 83 V was applied to the anode body for four hours using the anode lead. A fluorine-including tantalum oxide layer was formed on the surface of the anode body in this manner.

Next, the anode body with the fluorine-including oxide layer was immersed in an aqueous phosphoric acid solution, and a voltage of 88 V was applied to the anode body for four hours using the anode lead to form a Ta₂O₅-including oxide layer. The anode body was taken out of the aqueous phosphoric acid solution, washed with pure water, and then dried for 10 minutes in a drying oven regulated at 100° C. One hundred dielectric-film-coated anode bodies according to Example 2B each including a dielectric film formed on the surface of an anode body was obtained in this manner.

Next, in the same manner as in Example 2A, a solid electrolyte layer, a carbon-including layer, and a silver-including layer were formed on the surfaces of the dielectric films of 50 of the dielectric-film-coated anode bodies according to Example 2B. Capacitors according to Example 2B were produced in this manner.

### Examples 2C to 2E

Dielectric-film-coated anode bodies according to Examples 2C, 2D, and 2E were obtained in the same manner as in Example 2B, except that the voltage applied to the anode body to form the fluorine-including oxide layer was changed to 78 V, 73 V, and 68 V, respectively. The number of obtained dielectric-film-coated anode bodies according to Examples 2C, 2D, and 2E was 100 each. Fifty capacitors were produced for each of Examples 2C, 2D, and 2E in the same manner as in Example 2B, except that 50 of the dielectric-film-coated anode bodies were used for each of Examples 2C, 2D, and 2E instead of the 50 dielectric-film-coated anode bodies according to Example 2B.

### Comparative Example 2

Dielectric-film-coated anode bodies according to Comparative Example 2 were obtained in the same manner as in Example 2B, except that the voltage applied to the anode body to form the fluorine-including oxide layer was changed to 88 V and that the subsequent formation of an additional oxide layer using an aqueous phosphoric acid solution was omitted. The number of obtained dielectric-film-coated anode bodies according to Comparative Example 2 was 100. Capacitors according to Comparative Example 2 were produced in the same manner as in Example 2B, except that 50 of the dielectric-film-coated anode bodies according to Comparative Example 2 were used instead of the 50 dielectric-film-coated anode bodies according to Example 2B.

### Evaluation of Capacitance

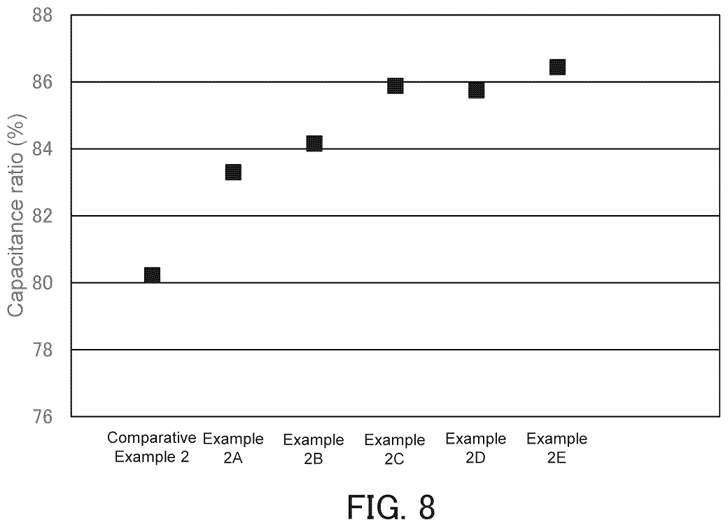

For the dielectric-film-coated anode bodies and the capacitors according to Examples 2A, 2B, 2C, 2D, and 2E and Comparative Example 2, the electrostatic capacitance at a frequency of 120 Hz was measured using an LCR meter for four-terminal measurement. Table 1 shows the results. The results are each an arithmetic average of the values measured for the 50 dielectric-film-coated anode bodies and the 50 capacitors. For each of Examples and Comparative Example 2, a ratio C₁/C₀ of an electrostatic capacitance C₁ of the capacitor to an electrostatic capacitance C₀ of the dielectric-film-coated anode body was defined as a capacitance ratio. FIG. 8 is a graph showing the capacitance ratios of Examples 2A to 2E and Comparative Example 2. The vertical axis of this graph represents the capacitance ratio.

As shown in Table 1, the electrostatic capacities of the capacitors according to Example 2A, Example 2B, Example 2C, Example 2D, Example 2E, and Comparative Example 2 were respectively lower than the electrostatic capacities of the dielectric-film-coated anode bodies according to Example 2A, Example 2B, Example 2C, Example 2D, Example 2E, and Comparative Example 2. This indicates that the solid electrolyte is not in contact with the entire dielectric film.

As shown in FIG. 8, the capacitance ratios of Examples 2A to 2E are 83% or more, which is higher than the capacitance ratio of Comparative Example 2. This is presumably because the affinity between the additional oxide layer formed on the anode body with the fluorine-including oxide layer using the aqueous phosphoric acid solution and the solid electrolyte was high enough to increase the contact area between the dielectric film and the solid electrolyte. As shown in FIG. 8, it has been confirmed that when the voltage applied to the anode body to form the fluorine-including oxide layer is low, the capacitance ratio tends to be high. It is thought that when the voltage applied to the anode body to form the fluorine-including oxide layer is low, the thickness of the additional oxide layer formed on the anode body with the fluorine-including oxide layer by using an aqueous phosphoric acid solution accounts for a larger proportion of the thickness of the dielectric film. This is considered to be the reason why the capacitance ratio tends to be high when the voltage applied to the anode body to form the fluorine-including oxide layer is low.

TABLE 1

| | Electrostatic | | |
|---|---|---|---|
| | capacitance C₀ of | | |
| | dielectric-film- | Electrostatic | Capacitance |
| | coated anode | capacitance C₁ of | ratio |
| | body [μF] | capacitor [μF] | C₁/C₀ [%] |
| Example 2A | 70.8 | 59.0 | 83.3 |
| Example 2B | 59.3 | 49.9 | 84.1 |
| Example 2C | 59.1 | 50.7 | 85.8 |
| Example 2D | 60.5 | 51.9 | 85.8 |
| Example 2E | 59.7 | 51.6 | 86.4 |
| Comparative | 60.7 | 48.7 | 80.2 |
| Example 2 | | | |

### Reference Example 1

Ultrasonic cleaning was performed for 10 minutes with a flat plate of metallic tantalum immersed in acetone, thereby washing the surface of the metallic tantalum. After that, acetone on the surface of the metallic tantalum was evaporated, and the surface of the metallic tantalum was washed with pure water, followed by drying the metallic tantalum in air.

Next, the metallic tantalum and a platinum foil as a counter electrode were disposed such that they were partially immersed in an aqueous phosphoric acid solution with a given distance therebetween. The portion of the metallic tantalum above the surface of the aqueous solution was connected to a positive electrode of a power-supply device, while the portion of the platinum foil above the surface of the aqueous solution was connected to a negative electrode of the power-supply device. A current was applied under constant voltage from the power-supply device, so that a voltage of 64 V was applied between the metallic tantalum and the counter electrode for 30 minutes. This caused an electrochemical reaction on the surface of the metallic tantalum being the anode to give an oxide film. The metallic tantalum with the oxidized film was taken out of the aqueous solution, washed with pure water, and then dried in air.

Next, the metallic tantalum with the oxide film as an anode and a platinum foil as a cathode were disposed such that they were partially immersed in an aqueous NH₄HF₂ solution with a given distance therebetween, and then the portions of the anode and the cathode above the surface of the aqueous solution were respectively connected to a positive electrode and a negative electrode of a power-supply device. A current was applied under constant voltage from the power-supply device, so that a voltage of 80 V was applied between the anode and the cathode for 10 minutes for anodization treatment. After that, the anode having undergone the anodization treatment was taken out of the aqueous solution, washed with pure water, and then dried. A sample according to Reference Example 1 in which a dielectric film was provided on the surface of metallic tantalum was obtained in this manner.

### Comparative Example 3

Ultrasonic cleaning was performed for 10 minutes with a flat plate of metallic tantalum immersed in acetone, thereby washing the surface of the metallic tantalum. After that, acetone on the surface of the metallic tantalum was evaporated, and the surface of the metallic tantalum was washed with pure water, followed by drying the metallic tantalum in air.

Next, the metallic tantalum as an anode and a platinum foil as a cathode were disposed such that they were partially immersed in an aqueous NH₄HF₂ solution with a given distance therebetween, and then the portions of the anode and the cathode above the surface of the aqueous solution were respectively connected to a positive electrode and a negative electrode of a power-supply device. A current was applied under constant voltage from the power-supply device, so that a voltage of 80 V was applied between the anode and the cathode for 10 minutes for anodization treatment. After that, the anode having undergone the anodization treatment was taken out of the aqueous solution, washed with pure water, and then dried. A sample according to Comparative Example 3 in which a dielectric film was provided on the surface of metallic tantalum was obtained in this manner.

### Comparative Example 4

Ultrasonic cleaning was performed for 10 minutes with a flat plate of metallic tantalum immersed in an acetone-filled container, thereby washing the surface of the metallic tantalum. After that, acetone on the surface of the metallic tantalum was evaporated, and the surface of the metallic tantalum was washed with pure water. The metallic tantalum was then dried in air.

Next, the metallic tantalum and a platinum foil as a counter electrode were disposed such that they were partially immersed in an aqueous phosphoric acid solution with a given distance therebetween. The portion of the metallic tantalum above the surface of the aqueous solution was connected to a positive electrode of a power-supply device, while the portion of the platinum foil above the surface of the aqueous solution was connected to a negative electrode of the power-supply device. A current was applied under constant voltage from the power-supply device, so that a voltage of 80 V was applied between the metallic tantalum and the counter electrode for 30 minutes. This caused an electrochemical reaction on the surface of the metallic tantalum being the anode to give an oxide film. The metallic tantalum with the oxide film was taken out of the aqueous solution, washed with pure water, and dried in air. A sample according to Comparative Example 4 including a dielectric film formed of a fluorine-free tantalum oxide was obtained in this manner.

### X-Ray Diffraction Measurement

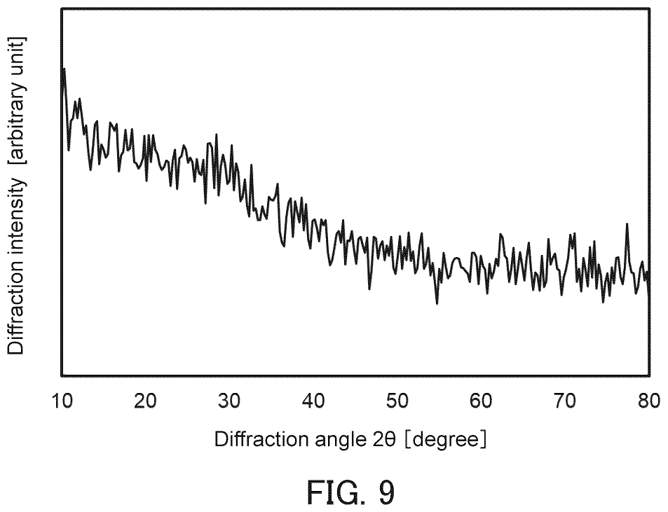

An XRD pattern of the dielectric film of the sample according to Reference Example 1 was obtained by 2θ/θ scan using an X-ray diffraction (XRD) apparatus SmartLab manufactured by Rigaku Corporation. Cu-Kα radiation was used as an X-ray source, the voltage was adjusted at 40 kV, the current was adjusted at 30 mA, and the scanning rate was adjusted at 10 deg./min. FIG. 9 shows the XRD pattern of the dielectric film of the sample according to Reference Example 1. No peak derived from a crystal structure is confirmed in the XRD pattern shown in FIG. 9, which indicates that the tantalum oxide film of the sample according to Reference Example 1 is amorphous.

### TOF-SIMS

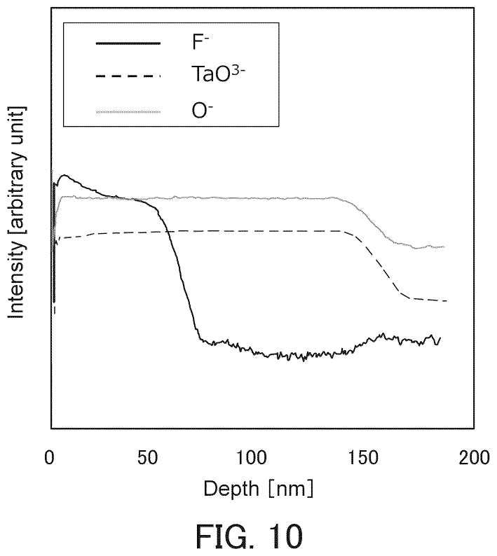

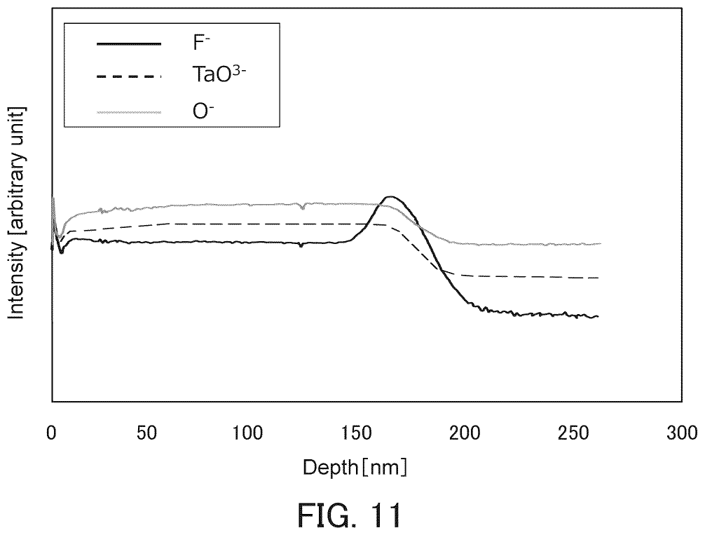

A piece having a given size was cut out of each of the samples according to Reference Example 1 and Comparative Example 3, and a specimen for TOF-SIMS was prepared by resin embedding. TOF-SIMS was performed on each of the specimens prepared from the samples according to Reference Example 1 and Comparative Example 3 using a TOF-SIMS apparatus TOF.SIMS 5 manufactured by IONTOF GmbH so as to perform composition analysis in the depth direction of the oxide film of the dielectric film. In the TOF-SIMS, a Bi beam was used as a primary ion beam. O₂⁺ was used as a sputtering ion species. FIG. 10 is a graph showing a relation between signal intensities of F⁻, TaO³⁻, and O⁻ and the depth in the depth profile obtained from the sample according to Reference Example 1 by TOF-SIMS. FIG. 11 is a graph showing a relation between signal intensities of F⁻, TaO³⁻, and O⁻ and the depth in the depth profile obtained from the sample according to Comparative Example 3 by TOF-SIMS. In FIGS. 10 and 11, the vertical axis represents the signal intensity of each ion, and the horizontal axis represents the depth of the dielectric film.

It is understood from FIG. 10 that the dielectric film of the sample according to Reference Example 1, which is provided on the metallic tantalum, includes a portion having a high fluorine concentration and a portion having a low fluorine concentration. The portion having a high fluorine concentration is present from the surface of the dielectric film to a depth of approximately 60 nm. On the other hand, the portion having a low fluorine concentration is present from a depth of approximately 75 nm of the dielectric film to a depth of approximately 150 nm. Judging from the signal intensity of F⁻ in the low fluorine concentration portion of the dielectric film, the fluorine concentration in this portion is 0.4% or less on the basis of the number of atoms. Variation in fluorine concentration is small in each of the portion having a high fluorine concentration and the portion having a low fluorine concentration. In FIG. 10, a depth of approximately 150 nm or more is understood to correspond to the metallic tantalum. No rise in fluorine concentration is confirmed at the boundary between the metallic tantalum and the dielectric film.

On the other hand, it is understood from FIG. 11 that the dielectric film of the sample according to Comparative Example 3 is present from the surface of the dielectric film to a depth of approximately 180 nm. In the sample according to Comparative Example 3, a rise in fluorine concentration is confirmed at the boundary between the metallic tantalum and the dielectric film. The reason may be that since the diffusion rate of fluoride ions is much greater than that of oxide ions, diffusion of fluoride ions into the metallic tantalum and generation of a tantalum fluoride occurred prior to formation of a tantalum oxide film by anodization. The thus-formed tantalum fluoride is poor in electrical insulation, and can decrease properties of the dielectric, the properties being required by a capacitor. Another concern is that the presence of such a tantalum fluoride in the vicinity of the metallic tantalum may result in non-uniform formation of a tantalum oxide film, leading to delamination of the tantalum oxide film. Therefore, a dielectric in which a tantalum fluoride is present in the vicinity of metallic tantalum is not suitable as a dielectric for capacitors. On the other hand, if chemical conversion is performed in advance using a fluorine-free solution, as in Reference Example 1, a fluorine-including tantalum oxide film can be easily formed on metallic tantalum without delamination.

### Capacitance and Dielectric Loss Tangent

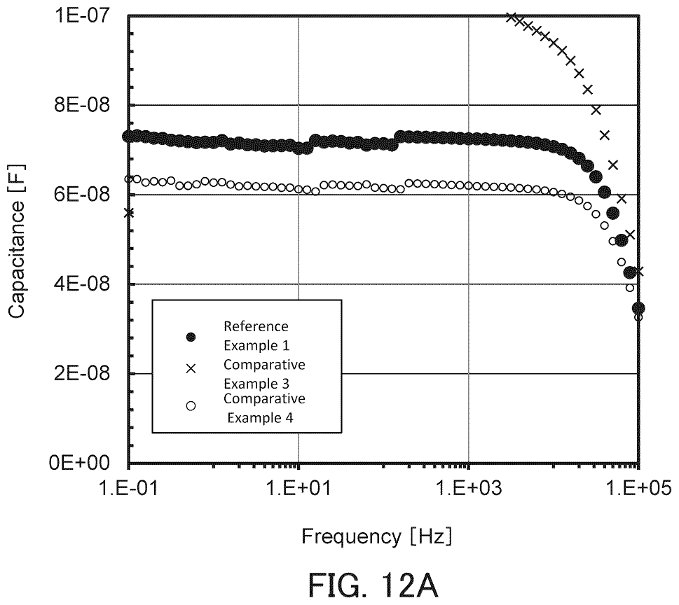

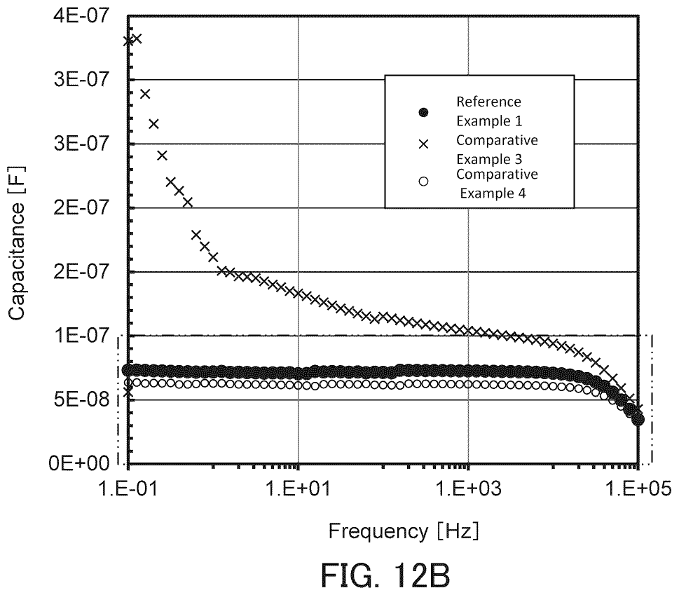

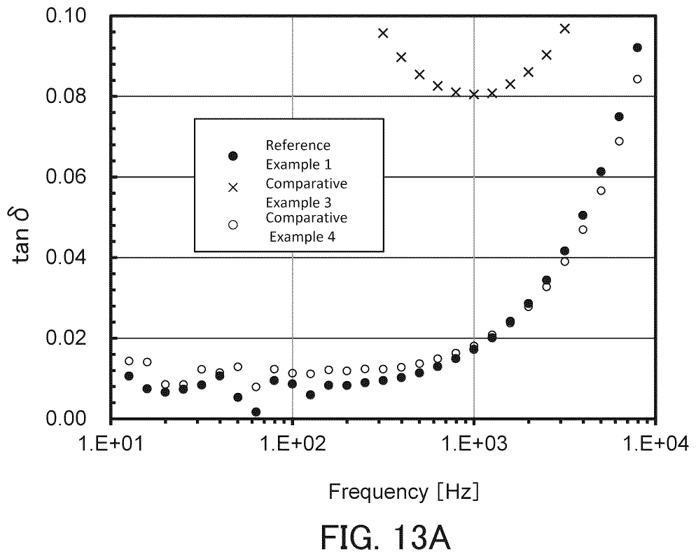

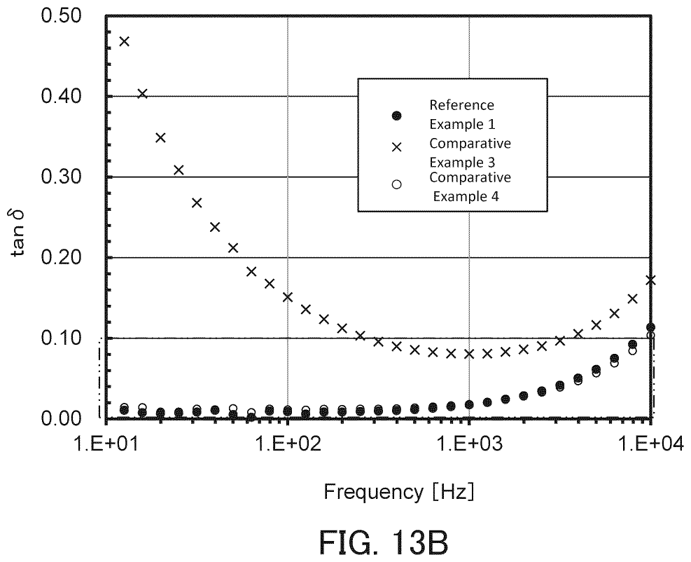

The sample of Reference Example 1 was attached to an electrochemical cell manufactured by BAS Inc., and dielectric properties of the capacitor according to Reference Example 1 were evaluated by the AC impedance measurement using platinum as a counter electrode. In this evaluation, an AC voltage with an amplitude of 10 to 100 mV and a frequency of 1 MHz to 0.1 Hz was applied to the capacitor according to Example 1B, and the capacitance was calculated from a resistance value at each frequency. FIGS. 12A and 12B are each a graph showing a relation between the capacitance of the capacitor and the frequency. In FIGS. 12A and 12B, the vertical axis represents the capacitance, and the horizontal axis represents the frequency. FIG. 12A shows an enlarged view of a portion surrounded by a dash-dot-dot line in FIG. 12B. Moreover, a dielectric loss tangent tan δ of the capacitor according to Reference Example 1 at each frequency was determined on the basis of this evaluation result. FIGS. 13A and 13B are each a graph showing a relation between the dielectric loss tangent tan δ of the capacitor and the frequency. In FIG. 13A, the vertical axis represents tan δ, and the horizontal axis represents the frequency. FIG. 13A shows an enlarged view of a portion surrounded by a dash-dot-dot line in FIG. 13B.

The sample according to Comparative Example 3 was attached to an electrochemical cell manufactured by BAS Inc., and the capacitance and the dielectric loss tangent tan δ of the capacitor according to Comparative Example 3 were determined in the same manner as in Reference Example 1 by the AC impedance measurement using platinum as a counter electrode. FIGS. 12A to 13B show the results.

The sample according to Comparative Example 4 was attached to an electrochemical cell manufactured by BAS Inc., and the capacitance and the dielectric loss tangent tan δ of the capacitor according to Comparative Example 4 were determined in the same manner as in Reference Example 1 by the AC impedance measurement using platinum as a counter electrode. FIGS. 12A to 13B show the results.

The dielectric layers of the samples according to Reference Example 1, Comparative Example 3, and Comparative Example 4 are on metallic tantalum having similar surface conditions, and it is understood that the dielectric layers of the samples have about the same surface area. According to FIGS. 12A and 12B, the capacitances of the capacitors according to Reference Example 1 and Comparative Example 3 are higher than the capacitance of the capacitor according to Comparative Example 4. Although having a high capacitance, the capacitor according to Comparative Example 3 has a high dielectric loss tangent tan δ as shown in FIGS. 13A and 13B. The dielectric loss tangent tan δ corresponds to energy consumed inside the capacitor, and it is understood that an electrical energy loss is large for the capacitor according to Comparative Example 3. On the other hand, the capacitor according to Reference Example 1 has not only a high capacitance but also a low dielectric loss tangent tan δ, from which it is understood that the capacitor according to Reference Example 1 is superior also in terms of a small electrical energy loss.

Table 2 shows the conditions for Example 1A, Example 1B, Examples 2A to 2E, Reference Example 1, and Comparative Examples 1 to 4.

TABLE 2

| | Shape of | Type of aqueous solution used | | |
|---|---|---|---|---|
| | metallic | for dielectric film formation | | |
| | tantalum | First | Second | Third |
| Example 1A | Flat plate | Aqueous | Aqueous NH₄HF₂ | Aqueous |
| | | phosphoric | solution | phosphoric |
| | | acid | | acid |
| | | solution | | solution |
| Example 2A | Sintered | Aqueous | Aqueous NH₄HF₂ | Aqueous |
| | powder | phosphoric | solution | phosphoric |
| | body | acid | | acid |
| | | solution | | solution |
| Example 1B | Flat plate | Aqueous | Aqueous mixture | Aqueous |
| | | phosphoric | solution of NaF | phosphoric |
| | | acid | and sodium | acid |
| | | solution | phosphate | solution |
| | | | buffer | |
| Comparative | Flat plate | Aqueous | Aqueous mixture | N/A |
| Example 1 | | phosphoric | solution of NaF | |
| | | acid | and sodium | |
| | | solution | phosphate | |
| | | | buffer | |
| Examples 2B | Sintered | Aqueous | Aqueous mixture | Aqueous |
| to 2E | powder | phosphoric | solution of NaF | phosphoric |
| | body | acid | and sodium | acid |
| | | solution | phosphate | solution |
| | | | buffer | |
| Comparative | Sintered | Aqueous | Aqueous mixture | N/A |
| Example 2 | powder | phosphoric | solution of NaF | |
| | body | acid | and sodium | |
| | | solution | phosphate | |
| | | | buffer | |
| Reference | Flat plate | Aqueous | Aqueous NH₄HF₂ | N/A |
| Example 1 | | phosphoric | solution | |
| | | acid | | |
| | | solution | | |
| Comparative | Flat plate | Aqueous | N/A | N/A |
| Example 3 | | NH₄HF₂ | | |
| | | solution | | |
| Comparative | Flat plate | Aqueous | N/A | N/A |
| Example 4 | | phosphoric | | |
| | | acid | | |
| | | solution | | |

### INDUSTRIAL APPLICABILITY

The capacitor of the present disclosure is advantageous in terms of suppressing capacitance degradation due to a solid electrolyte.

What is claimed is:

1. A capacitor comprising:
metallic tantalum;
a solid electrolyte; and
a tantalum oxide film disposed between the metallic tantalum and the solid electrolyte, wherein
the tantalum oxide film includes a first portion including fluorine and a second portion in contact with the first portion, the second portion being closer to the solid electrolyte than the first portion in a thickness direction of the tantalum oxide film, and
a fluorine concentration in the second portion is lower than a fluorine concentration in the first portion.

2. The capacitor according to claim 1, wherein
the tantalum oxide film further includes a third portion in contact with the first portion, the third portion being closer to the metallic tantalum than the first portion in the thickness direction of the tantalum oxide film, and
a fluorine concentration in the third portion is lower than the fluorine concentration in the first portion.

3. The capacitor according to claim 1, wherein the first portion is amorphous.

4. The capacitor according to claim 1, wherein
the first portion has a composition represented by TaOₓ₁F_{y1}, and
the composition satisfies a requirement 0<x1<2.5 and a requirement 0<y1≤0.4.

5. The capacitor according to claim 1, wherein
the second portion has a composition represented by TaOₓ₂F_{y2}, and
the composition satisfies a requirement 0<x2<2.5 and a requirement 0≤y2<0.015.

6. The capacitor according to claim 2, wherein
the third portion has a composition represented by TaOₓ₃F_{y3}, and
the composition satisfies a requirement 0<x3<2.5 and a requirement 0≤y3<0.015.

7. The capacitor according to claim 1, wherein
in a depth profile of elements or ions in the tantalum oxide film, a coefficient of variation of signal intensity of oxygen (O) or an oxygen ion O⁻ in the first portion and the second portion is 0.09 or less.

8. An electrical circuit comprising the capacitor according to claim 1, wherein the capacitor is mounted to the electrical circuit.

9. A circuit board comprising the capacitor according to claim 1, wherein the capacitor is mounted to an electrical circuit formed on the circuit board.

10. An apparatus comprising the capacitor according to claim 1, wherein:
the capacitor is mounted to an electrical circuit formed on a circuit board, and
the apparatus is equipped with the circuit board.
